(19) United States
(12) Patent Application Publication
(10) Pub. No.: US 2005/0223227 A1
(43) Pub. Date: Oct. 6, 2005

(54) Addressable authentication in a scalable, reconfigurable communication architecture

(76) Inventor: William C. DeLeeuw, Portland, OR (US)

Correspondence Address: INTEL CORPORATION, P.O. BOX 5326, SANTA CLARA, CA, 95056-5326, US

(21) Appl. No.: 11/008,698

(22) Filed: Dec. 8, 2004

Related U.S. Application Data
(63) Continuation-in-part of application No. 10/813,058, filed on Mar. 31, 2004.
(63) Continuation-in-part of application No. 10/813,063, filed on Mar. 31, 2004.

(51) Int. Cl. G06F 15/00

(52) U.S. Cl. 713/168

(57) ABSTRACT

Briefly, in accordance with one embodiment of the invention, a reconfigurable communication device may include an authentication element to authenticate configuration requests intended to configure a configurable element within the reconfigurable communication device. In the event a configuration request is authorized, the authentication element passes the configuration request onto the configurable element. In the event a configuration request is not authorized, the authentication node takes measures to prevent the configuration request from configuring the configurable element, including discarding the configuration request or resetting the reconfigurable communication device. In the event a configuration request is not addressed to the authentication element, the configuration request may be readdressed to the authentication element. By interposing the authentication element between a configurable element and an external input, the authentication element prevents undesired or unauthorized configuration of the reconfigurable communication device.

### CROSS-REFERENCE TO RELATED APPLICATIONS

The present application is a continuation-in-part of patent application Ser. No. 10/813,058, Attorney Docket No. P18367 entitled “Security Measures in a Reconfigurable Communication System” filed Mar. 31, 2004. Said application P18367 is hereby incorporated by reference in its entirety. The present application is also a continuation-in-part of patent application Ser. No. 10/813,063, Attorney Docket No. P18366 entitled “Multi-Interfacing in a Reconfigurable System” filed Mar. 31, 2004. Said application P18366 is hereby incorporated by reference in its entirety.

### BACKGROUND OF THE INVENTION

Reconfigurable communication architectures (RCAs) for wireless communication devices typically should ensure that the radio portion of the system cannot radiate outside of regulatory specifications. Several avenues may exist for attacking a reconfigurable radio ranging from unintentional to malicious. Such attacks may be based on, for example, inducing unauthorized or unintended behavior of the analog front end (AFE) of the wireless device. A configuration attack may be considered, among other things, as a method for hijacking a reconfigurable communication device wherein a reconfigurable element within the device may be configured to act as an attacker. In such a case, the attacker may introduce unauthorized data and or configuration settings into the analog front end of the wireless communication device, resulting in unanticipated or undesired radiation.

### DESCRIPTION OF THE DRAWING FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a reconfigurable communication system in accordance with one or more embodiments of the invention;

FIG. 2 is a block diagram of a reconfigurable communication system as shown in FIG. 1 that further shows an authentication node in accordance with one or more embodiments of the invention;

FIG. 3 is a block diagram illustrating information flow in a reconfigurable communication system in accordance with one or more embodiments of the invention;

FIG. 4 is a block diagram of a host input/output node that includes a firewall in accordance with one or more embodiments of the invention; and

FIG. 5 is a wireless local or personal area network communication system in accordance with one or more embodiments of the invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail.

Some portions of the detailed description that follows are presented in terms of algorithms, programs and symbolic representations of operations on data bits or binary digital signals within a computer memory. These algorithmic descriptions and representations may be the techniques used in the data processing arts to convey the arrangement of a computer system to operate according to the programs.

An algorithm may be generally considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as processing, computing, calculating, determining, or the like, refer to the action or processes of a computer or computing system, or similar electronic computing device, that manipulate or transform data represented as physical, such as electronic, quantities within the registers or memories of the computing system into other data similarly represented as physical quantities within the memories, registers or other such information storage, transmission or display devices of the computing system.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), flash memory, magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

It should be understood that embodiments of the present invention may be used in a variety of applications. Although the present invention is not limited in this respect, the circuits disclosed herein may be used in many apparatuses such as in the transmitters and receivers of a radio system. Radio systems intended to be included within the scope of the present invention include, by way of example only, wireless personal area networks (WPAN) such as a network in compliance with the WiMedia Alliance, a wireless local area networks (WLAN) devices and wireless wide area network (WWAN) devices including wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), and the like, although the scope of the invention is not limited in this respect.

Types of wireless communication systems intended to be within the scope of the present invention include, although not limited to, Wireless Local Area Network (WLAN), Wireless Wide Area Network (WWAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wideband CDMA (WCDMA), CDMA-2000, and the like, although the scope of the invention is not limited in this respect.

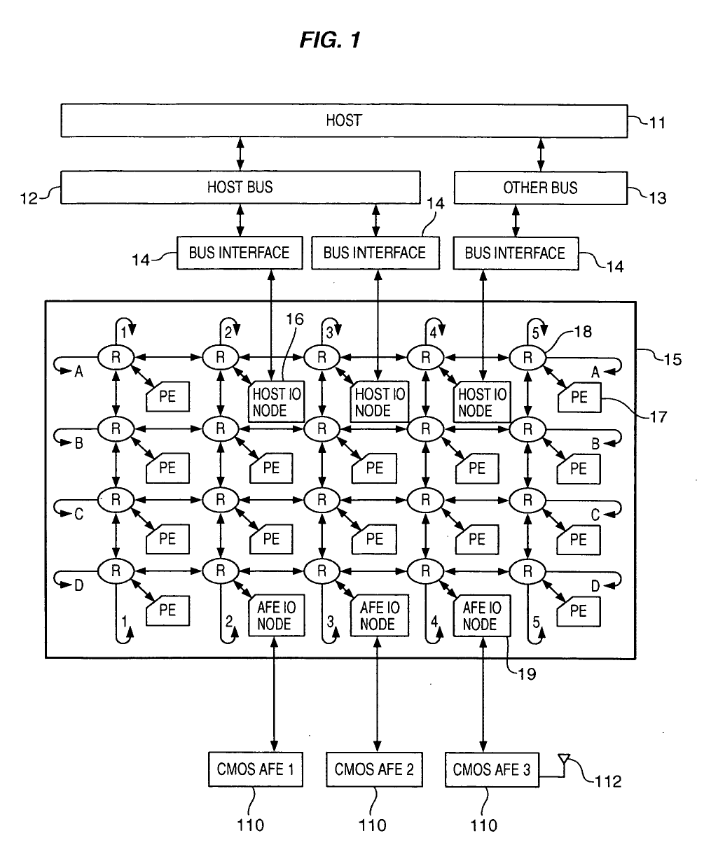

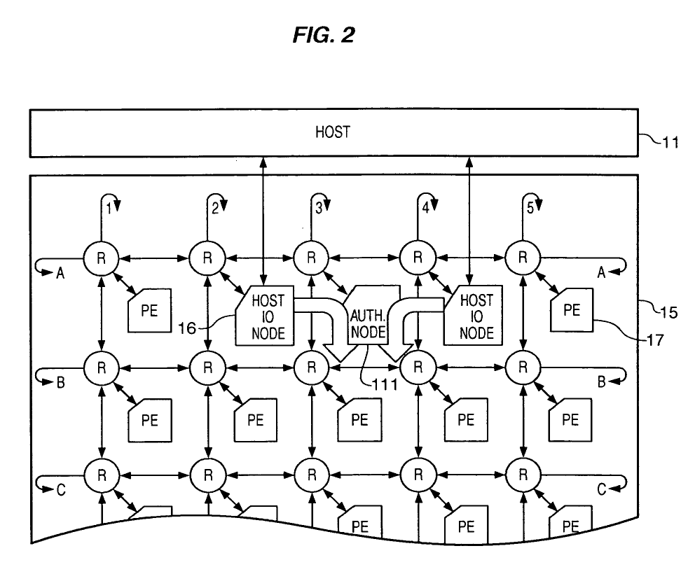

Referring now to FIG. 1, a block diagram of a reconfigurable communication system in accordance with one or more embodiments of the invention will be discussed. Reconfigurable communication system 15 may comprise a network of interconnected nodes. The interconnected nodes may include, but are not limited to, protocol elements (PEs), such as node 17, host input/output (IO) nodes, such as node 16, and analog front-end (AFE) IO nodes, such as node 19. The nodes may be interconnected by means of routing nodes (R), such as node 18. A host IO node, such as node 16, may be coupled to a bus interface 14. A bus interface 14 may be coupled to a host bus 12 or other bus 13, which, in turn, may be coupled to a host 11. In one or more embodiments of the invention, other bus 13 may also be a host bus, or alternatively host bus 12 and other bus 13 may be channels of a bus system such as a Peripheral Component Interconnect Express (PCI Express) bus, although the scope of the invention is not limited in this respect. A host 11 may, for example, comprise a computing platform, but is not limited thereto. An AFE IO node, such as node 19, may be coupled to an AFE 110, which may be implemented in complementary metal-oxide-semiconductor (CMOS) technology, for example as shown in FIG. 2, but which may be implemented in other materials using other processes as well, and the scope of the invention is not limited in this respect. An AFE 110 may be used to interface with a communication medium, for example via radio-frequency radiation, and it may be coupled to further transmit and/or receive equipment and/or to an antenna 112 or other appropriate transducer, where such an antenna may be a monopole, dipole, loop, planar antenna, reflector, array, and so on, although the scope of the invention is not limited in this respect. In one or more alternative embodiments of the invention, one or more of AFEs 110 may be incorporated as part of reconfigurable communication system 15. For example, one or more of AFEs 110 may include reconfigurable radio components such as switches, capacitors, inductors, diplexers, and so on, to allow AFE 110 to be reconfigurable to operate at one or more selectable frequencies or in accordance with one or more communication protocols, although the scope of the invention is not limited in this respect. Furthermore, although reconfigurable communication system 15 and AFEs 110 may be discussed herein as being implemented as part of a wireless communication device or system, it should be noted that in one or more embodiments of the invention, part or all of reconfigurable communication system 15 or AFEs 110 may be configurable to operate on a wired communication system or according to one or more wired communication protocols such as an Ethernet protocol, although the scope of the invention is not limited in this respect. In such embodiments, wired and wireless protocols may coexist within the same reconfigurable device, although the scope of the invention is not limited in this respect.

Referring now to FIG. 2, a block diagram of a reconfigurable communication system as shown in FIG. 1 that further shows an authentication node in accordance with one or more embodiments of the invention will be discussed. Authentication node 111 may be used in implementing security features according to one or more embodiments of the invention. A reconfigurable communication system 15 may also contain two or more authentication nodes 111, although the scope of the invention is not limited in this respect. Authentication node 111 may be disposed within reconfigurable communication system 15 to validate configuration requests received from host IO nodes 16. In such an arrangement, configuration requests may be ensured to be from authentication node 111 rather than from an external source in that they may not be interposed between authentication node 111 and reconfigurable communication system 15. Furthermore, internal placement of authentication node 111 may protect the validation key or hash used by authentication node 111 from being accessed by an external source or device, although the scope of the invention is not limited in this respect. In one or more embodiments of the invention, the contents of a configuration packet, for example a portion following an address portion of the configuration packet, may be encrypted. For example, a configuration packet may include information how to implement a baseband operation that is desired to be protected from detection or otherwise unavailable to an unintended recipient. In such an arrangement, authentication node 111 may operate as a decryption point at which the contents of the configuration packet may be decrypted. In one or more embodiments, authentication node 111 may include a private key for decrypting encrypted information in a configuration request packet, although the scope of the invention is not limited in this respect. Optionally, the packets may be encrypted using a corresponding public key, although the scope of the invention is not limited in this respect. By disposing authentication node 111 internal to reconfigurable communication system 15, unencrypted or decrypted information may be prevented from leaving reconfigurable communication system 15, and furthermore may maintain the private decryption key safely within reconfigurable communication system 15, although the scope of the invention is not limited in this respect.

In one or more embodiments of the present invention, one or more authentication nodes 111 may be interposed between a host input/output node 16 and one or more computational elements such as protocol element nodes 17, routing nodes 18, or analog front end nodes 19, for example. In one or more embodiments of the invention, an authentication node 111 may be referred to as interposed between host input/output nodes 16 and one or more computational elements by being physically disposed between a host input/output node 16 and one or more computational elements, and in an alternative embodiment authentication node 111 may be referred to as interposed between host input/output nodes 16 and one or more computational elements by being logically disposed between a host input/output node 16 and one or more computational elements, and in yet an alternative embodiment interposed may include a combination of physical and logical disposition of authentication node 111 between a host input/output node and one or more computational elements, although the scope of the invention is not limited in this respect.

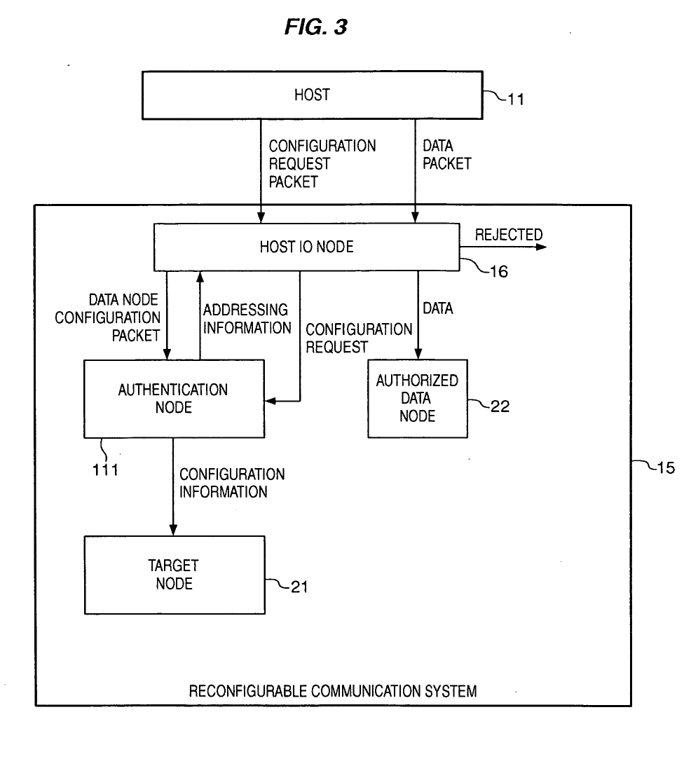

Referring now to FIG. 3, a block diagram illustrating information flow in a reconfigurable communication system in accordance with one or more embodiments of the invention will be discussed. In the embodiment shown in FIG. 3, at least two types of information may be processed: configuration request information and data for transmission, although the scope of the invention is not limited in this respect. Configuration request information may be utilized to reconfigure all or part of a node of reconfigurable communication system 15. Data for transmission may affect transmission or control characteristics of a generated physical signal but may not affect the configuration of a node. The arrangement as shown in FIG. 3 may prevent unauthorized users from inserting spurious information of either type into reconfigurable communication system 15.

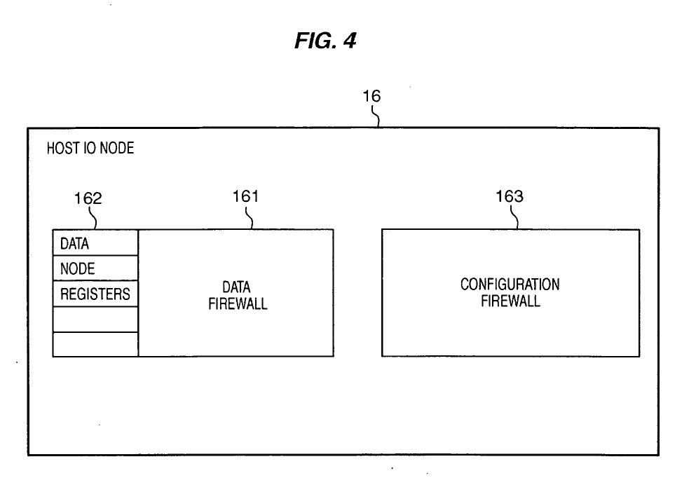

In the case of configuration request information, a host 11 may send a configuration request packet that may be intended for a programmable target element 21, to the reconfigurable communication system 15, where it may be processed by a host 10 node 16. In one embodiment of the invention, a configuration request packet may include configuration information to configure two or more target elements 21, although the scope of the invention is not limited in this respect. Data packets may also be transferred between Host IO node 16 and Host 11 in a bidirectional manner, although the scope of the invention is not limited in this respect. Host IO node 16 may contain a configuration firewall 163, for example as shown in FIG. 4, which may ensure that configuration request packets are directed to an authentication node 111. Such an arrangement may be accomplished by scanning the configuration request packets to make sure the reconfiguration request packets are destined for an authentication node 111. In the event it is determined that a reconfiguration request packet is not destined for an authentication node, the destination may be changed so that the configuration request packet is routed an authentication node 111. In alternative embodiment, other security measures may be taken, for example, the configuration request packet may be discarded, or the system may be reset, although the scope of the invention is not limited in this respect. Authentication node 111 may be responsible for verifying that the configuration request packet is valid, for example that it is an authorized reconfiguration request. In one or more embodiments of the invention, such verifying may include verification of a digital signature in a packet, for example where an asymmetric key may be utilized, although the scope of the invention is not limited in this respect. In the event it is determined that the reconfiguration request is not valid, authentication node 111 may discard the packet or take other security measures, for example to reset the system. In the event the reconfiguration request packet is determined to be valid, authentication node 111 may forward configuration information contained in the configuration request packet to the target node 21, although the scope of the invention is not limited in this respect.

As shown in and described with respect to FIG. 3, data for transmission may also be processed in accordance with one or more embodiments of the invention. In such an scenario, a pre-authentication scheme may be utilized to prevent an unauthorized entity from introducing data for transmission by the reconfigurable communication system 15, and to prevent the introduced data from causing undesirable transmission effects, for example, power levels and spectral shaping, although the scope of the invention is not limited in this respect.

Prior to presenting actual data for transmission, an authorized host 11 may submit a data node configuration packet to the reconfigurable communication system 15. A data node configuration packet may be a type of configuration request packet containing data node addressing information and targeting a host IO node 16. Within the reconfigurable communication system 15, the data node configuration packet may be sent to authorization node 111. Authentication node 111 may verify whether or not the data node configuration packet is signed by an authorized entity. In the event authentication node 111 determines that the data node configuration packet is not authorized, the packet may be discarded, or alternatively other security measures may be taken, for example resetting the system, although the scope of the invention is not limited in this respect. In the event authentication nodes determines that the data node configuration packet is signed by an authorized entity, authentication node 111 may forward at least addressing information from the data node configuration packet to one or more host IO nodes 16. In some embodiments, this may be accomplished via an internal, secure interface between authentication node 111 and host IO node 16, although the scope of the invention is not limited in this respect.

Referring now to FIG. 4, a block diagram of a host input/output node that includes a firewall in accordance with one or more embodiments of the invention will be discussed. As shown in FIG. 4, host IO node 16 may optionally include a data firewall 161. Reconfigurable communication system 15 may utilize multiple types of host 10 nodes 16, where one or more of the host IO nodes 16 may deal with both transmission data and configuration information, for example as shown in FIG. 3, and thus may include firewalls 161 and 163, and one or more other of the host IO nodes 16 include one or the other of data firewall 161 or configuration firewall 163, although the scope of the invention is not limited in this respect. Address information received from authentication node 111 may be received by a host IO node 16 and may be used to configure data firewall 161 to permit data from the authorized entity to be sent to particular nodes in reconfigurable communication system 15. In one embodiment, the data firewall 161 may include data node registers 162 for storing information on valid nodes to which an authorized entity may send data for transmission. In some embodiments, data node registers 162 may comprise memory separate from and accessed by the data firewall 161. Furthermore, such memory may be used by a single data firewall 161 of a single host 10 node 16, or it may be shared by more than one data firewall and/or host IO node 16, although the scope of the invention is not limited in this respect.

Once data firewall 161 has been configured using address information, data firewall 161 may handle data packets. A data packet may be sent from a host 11 to a host IO node 16, where it may be examined by a data firewall 161. If the data packet is addressed to an authorized data node 22, the data may be forwarded to the node 22 by host IO node 16. If the data packet is not addressed to an authorized data node 22, host IO node 16 may reject and discard the data packet, or alternatively may take other security measures, for example resetting the system, although the scope of the invention is not limited in this respect.

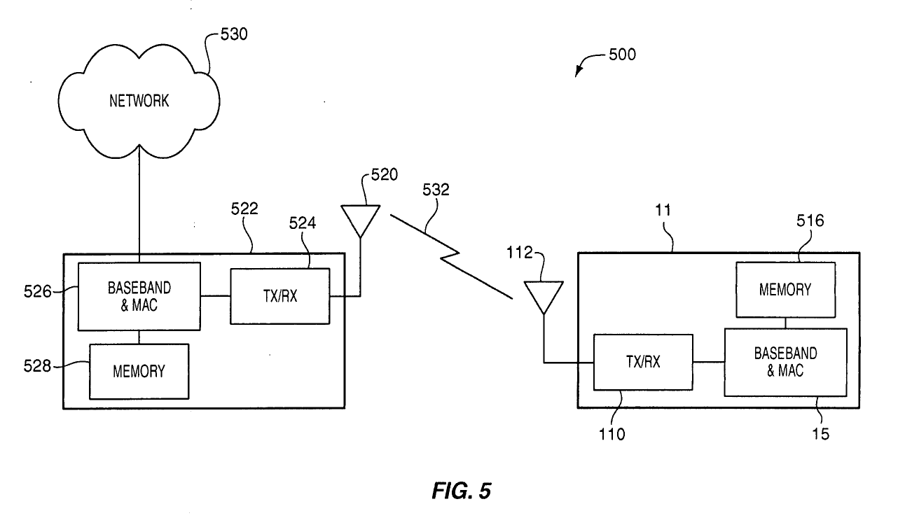

Referring now to FIG. 5, a wireless local or personal area network (WLAN or WPAN) communication system in accordance with one or more embodiments of the present invention will be discussed. Although a wireless network communication system is shown in FIG. 5, in one or more alternative embodiments of the invention, the wireless communication system may include one or more wired communication links, or may be substituted with an analogous wired communication system, although the scope of the invention is not limited in this respect. In the WLAN or WPAN communications system 500 shown in FIG. 5, host 11 may be for example a mobile or remote unit such as a mobile computer or information handling system, a desktop computer, or a cellular telephone, and analog front end 110 may be a wireless transceiver to couple to antenna 112. Reconfigurable communication system 15 may be a processor to provide baseband and media access control (MAC) processing functions. Reconfigurable communication system 15 in one embodiment may comprise a single processor, or alternatively may comprise a baseband processor and an applications processor, although the scope of the invention is not limited in this respect. Reconfigurable communication system 15 may couple to a memory 516 which may include volatile memory such as DRAM, non-volatile memory such as flash memory, or alternatively may include other types of storage such as a hard disk drive, although the scope of the invention is not limited in this respect. Some portion or all of memory 516 may be included on the same integrated circuit as reconfigurable communication system 15, or alternatively some portion or all of memory 516 may be disposed on an integrated circuit or other medium, for example a hard disk drive, that is external to the integrated circuit of reconfigurable communication system 15, although the scope of the invention is not limited in this respect.

Host 11 may communicate with access point 522 via wireless communication link 532, where access point 522 may include at least one antenna 520, transceiver 524, processor 526, and memory 528. In an alternative embodiment, access point 522 and optionally host 11 may include two or more antennas, for example to provide a spatial division multiple access (SDMA) system or a multiple input, multiple output (MIMO) system, although the scope of the invention is not limited in this respect. Access point 522 may couple with network 530 so that host 11 may communicate with network 530, including devices coupled to network 530, by communicating with access point 522 via wireless communication link 532. In one or more alternative embodiments of the present invention, wireless communication link 532 may be a wired communication link, although the scope of the invention is not limited in this respect. Network 530 may include a public network such as a telephone network or the Internet, or alternatively network 530 may include a private network such as an intranet, or a combination of a public and a private network, although the scope of the invention is not limited in this respect. Communication between host 11 and access point 522 may be implemented via a wireless personal area networks (WPAN) such as a network in compliance with the WiMedia Alliance, a wireless local area network (WLAN), for example a network compliant with a an Institute of Electrical and Electronics Engineers (IEEE) standard such as IEEE 802.11a, IEEE 802.11b, IEEE 802.11n, IEEE 802.16, HiperLAN-II, HiperMAN, Ultra-Wideband (UWB), and so on, although the scope of the invention is not limited in this respect. In another embodiment, communication between host 11 and access point 522 may be at least partially implemented via a cellular communication network compliant with a Third Generation Partnership Project (3GPP or 3G) standard, a Wideband CDMA (WCDMA) standard, and so on, although the scope of the invention is not limited in this respect.

Although the invention has been described with a certain degree of particularity, it should be recognized that elements thereof may be altered by persons skilled in the art without departing from the spirit and scope of the invention. It is believed that the addressable authentication in a scalable, reconfigurable communication architecture of the present invention and many of its attendant advantages will be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

1. An apparatus, comprising:
one or more computational elements, wherein at least one of the computational elements may be configured by a host input/output node to operate according to one or more communication protocols; and
one or more authentication elements to receive a configuration request from the host input/output node and to provide the configuration request to a selected one of the computation elements when at least one of the authentication elements authenticates the configuration request, wherein at least one of the authentication elements is interposed between the host input/output node and at least one of the computational elements.

2. An apparatus as claimed as claimed in claim 1, wherein the authentication elements and the computational elements are disposed within the same device.

3. An apparatus as claimed in claim 1, wherein the one or more communication protocols include at least one of a wired or a wireless communication protocol.

4. An apparatus as claimed in claim 1, wherein the computational elements may be configured to operate according to the same communication protocol.

5. An apparatus as claimed in claim 1, wherein one of the computational elements may be configured to operate according a first communication protocol, and wherein another of the computation elements may be configured to operate according to a second communication protocol.

6. An apparatus as claimed in claim 1, wherein the authentication element includes a private key to decrypt information contained in the configuration request.

7. An apparatus, comprising:
a baseband processor including two or more host input/output nodes, two or more protocol elements, and two or more radio nodes, and one or more authentication nodes, wherein at least one of the authentication nodes is interposed between the host input/output nodes and the protocol elements; and
a radio-frequency transceiver;
the authentication node to receive a configuration request from a host device to configure the baseband processor to operate according to one of a selectable number of communication protocols provided by one of the two or more protocol elements, wherein one of the authentication node receives the configuration request, and if authenticated, passes the configuration request to a selected one of the protocol elements.

8. An apparatus as claimed in claim 7, wherein one of the authentication node is the only authentication element in the baseband processor.

9. An apparatus as claimed in claim 7, wherein the baseband processor further includes one or more routing nodes to route the configuration request in the baseband processor.

10. An apparatus as claimed in claim 7, wherein the baseband processor further includes one or more radio nodes to couple the protocol elements to two or more radios disposed in the radio transceiver.

11. An apparatus as claimed in claim 7, wherein the authentication node prevents a reconfiguring of the baseband processor when a configuration request is not authenticated.

12. An apparatus as claimed 7, wherein the authentication nodes, when the configuration request is not authenticated, prevent a reconfiguration of the baseband processor by performing at least one of discarding the configuration request, resetting the baseband processor.

13. An apparatus as claimed in claim 7, wherein at least one of the authentication nodes includes a private key to decrypt information contained in the configuration request.

14. A method, comprising:
receiving a configuration request to configure a configurable communication element;
routing the configuration request to an authentication element to determine whether the configuration request is valid; and
in the event it is determined that the configuration request is valid, routing the configuration request from the authentication element to the configurable communication element.

15. A method as claimed in claim 14, further comprising, determining whether a configuration request is addressed to the authentication element, and if it is determined that the configuration request is not addressed to the authentication element, readdressing the configuration request to the authentication element.

16. A method as claimed in claim 14, wherein the configuration request includes configuration information to configure two or more reconfigurable elements.

17. A method as claimed in claim 14, further comprising addressing the configuration request to an authentication node regardless of whether the configuration request is addressed to another destination.

18. A method as claimed in claim 14, further comprising decrypting information contained in the configuration request via a private key included with at least one of the authentication elements.

19. An article comprising a storage medium having stored thereon instructions that, when executed by a computing platform, result in authentication of a configuration request by:
receiving a configuration request to configure a configurable communication element;
routing the reconfiguration request to an authentication element to determine whether the configuration request is valid; and
in the event it is determined that the configuration request is valid, routing the configuration request from the authentication element to the configurable communication element.

20. An article as claimed in claim 19, wherein the instructions, when executed, further result in authentication of a configuration request by determining whether a configuration request is addressed to the authentication element, and if it is determined that the configuration request is not addressed to the authentication element, readdressing the configuration request to the authentication element.

21. An article as claimed in claim 19, wherein the configuration request includes configuration information to configure two or more reconfigurable elements.

22. An article as claimed in claim 19, wherein the instructions, when executed, further result in authentication of a configuration request by addressing the configuration request to an authentication node regardless of whether the configuration request is addressed to another destination.

23. An article as claimed in claim 19, wherein the instructions, when executed, further result in authentication of a configuration request by decrypting information contained in the configuration request via a private key included with at least one of the authentication elements.

24. An apparatus, comprising:
a host processor;
a baseband processor including two or more host input/output nodes, two or more protocol elements, and two or more radio nodes, and one or more authentication nodes, wherein at least one of the authentication nodes is interposed between the host input/output nodes and the protocol elements;
a radio-frequency transceiver; and
an omnidirectional antenna to couple to the radio-frequency transceiver;
at least one of the authentication nodes to receive a configuration request from a host device to configure the baseband processor to operate according to one of a selectable number of communication protocols provided by one of the two or more protocol elements, wherein at least one of the authentication nodes receives the configuration request, and if authenticated, passes the configuration request to a selected one of the protocol elements.

25. An apparatus as claimed in claim 20, wherein at least one of the authentication nodes is the only authentication element in the baseband processor.

26. An apparatus as claimed in claim 20, wherein the baseband processor further includes one or more routing nodes to route the configuration request in the baseband processor.

27. An apparatus as claimed in claim 20, wherein the baseband processor further includes one or more radio nodes to couple the protocol elements to two or more radios disposed in the radio transceiver.

28. An apparatus as claimed in claim 20, wherein one of the authentication nodes prevents a reconfiguring of the baseband processor when a configuration request is not authenticated.

29. An apparatus as claimed 20, wherein one of the authentication nodes, when the configuration request is not authenticated, prevents a reconfiguration of the baseband processor by performing at least one of discarding the configuration request, resetting the baseband processor.

30. An apparatus as claimed in claim 20, wherein at least one of the authentication nodes includes a private key to decrypt information contained in the configuration request.
